(19) United States
(12) Patent Application Publication
(10) Pub. No.: US 2026/0300686 A1
(43) Pub. Date: Oct. 1, 2026

(54) RECURRENT SELF-REPRESENTATION NEURAL NETWORK

(71) Applicant: InnerVoice PBC, Berkeley, CA (US)

(72) Inventors: Aza Benjamin Blum Raskin, Berkeley, CA (US); Evan Howell Sharp, San Francisco, CA (US); Christopher Isaac Stone, Corte Madera, CA (US)

(73) Assignee: InnerVoice PBC, Berkeley, CA (US)

(21) Appl. No.: 19/094,433

(22) Filed: Mar. 28, 2025

(51) Int. Cl. G06N 3/044; G06N 3/0455; G06N 3/048

(52) U.S. Cl. CPC G06N 3/044; G06N 3/0455; G06N 3/048

(57) ABSTRACT

Disclosed are systems and methods that implement a form of subjective awareness of experience for a neural network and provide the ability to quantitively determine if a neural network is self-aware. The disclosed implementations include a recurrent self-representation system that includes a neural network and an introspective system that is communicatively coupled with the neural network. The introspective system generates and provides recurrent self-representations to the neural network as inputs of an input set. The neural network utilizes those recurrent self-representations to understand its own experience and utilize that understanding to influence the neural networks processing of inputs and generation of outputs.

### BACKGROUND

Neural networks have emerged as a fundamental technology in the field of machine learning and artificial intelligence, drawing inspiration from biological neural networks found in human brains. These computational models consist of interconnected nodes, or “neurons,” arranged in layers, typically including an input layer, one or more hidden layers, and an output layer. During operation, each neuron receives input signals, applies weights and mathematical transformations to these signals, and produces an output signal that is propagated through the network. The network learns to perform specific tasks by adjusting these weights through a process called training, wherein the network is exposed to numerous examples and iteratively minimizes the difference between its predicted outputs and desired outputs.

Despite their widespread adoption and success in various applications, neural networks face several significant limitations and drawbacks. For example, the “black box” nature of neural networks makes it difficult to interpret their decision-making process, raising concerns in applications where explainability is crucial, such as healthcare or financial services. Additionally, neural networks can be computationally intensive to train and operate, requiring substantial processing power and energy consumption, and they may exhibit unstable behavior when presented with input data that differs significantly from their training data, a phenomenon known as poor generalization. Furthermore, as neural networks become increasingly sophisticated, questions arise regarding their potential for sentience or consciousness, creating ethical and philosophical challenges in their deployment. The inability to definitively measure or detect sentience in these systems, coupled with the lack of scientific consensus on the necessary conditions for consciousness, introduces significant uncertainty in applications where the distinction between mere pattern recognition and genuine understanding is crucial.

### BRIEF DESCRIPTION OF DRAWINGS

The detailed description is described with reference to the accompanying figures.

FIG. 1 is an example environment illustrating inputs that may be received by a recurrent self-representation system and outputs that may be produced by the recurrent self-representation system, in accordance with described implementations.

FIG. 2A is a block diagram illustrating additional details of the recurrent self-representation system illustrated in FIG. 1, in accordance with described implementations.

FIG. 2B is a block diagram illustrating additional details of the neural network illustrated in FIG. 2A, in accordance with described implementations.

FIG. 3 is an example autoencoder training/update process, in accordance with described implementations.

FIG. 4 is an example recurrent self-representation process, in accordance with described implementations.

FIG. 5 is an example internal self-representation generation process, in accordance with described implementations.

FIG. 6 is an example self-reflection generation process, in accordance with described implementations.

FIG. 7 is an example self-awareness determination process, in accordance with described implementations.

FIG. 8 is another example self-awareness determination process, in accordance with described implementations.

FIG. 9 is another example self-awareness determination process, in accordance with described implementations.

FIG. 10 is an example neural network update process, in accordance with described implementations.

FIG. 11 is a block diagram illustrating an exemplary computing resource upon which the recurrent self-representation service may operate, in accordance with described implementations.

### DETAILED DESCRIPTION

Disclosed are systems and methods that implement a form of subjective awareness of experience for a neural network and provide the ability to quantitively determine if a neural network is self-aware. As discussed further below, disclosed implementations include a recurrent self-representation system (“RSRS”) that includes a neural network and an introspective system that is communicatively coupled with the neural network such that the introspective system generates and provides recurrent self-representations (“RSR”) of the neural network to the neural network. An RSR may include an internal self-representation and/or a self-reflection. The RSR may be included in an input set that is provided to the neural network and influences the neural network, thereby making the neural network self-aware.

As discussed further below, the internal self-representation is produced from activation values observed from neurons of the neural network as the neural network processes an input set of inputs. Generally, the internal self-representation provides the neural network with a self-reflection of itself, similar to a functional Magnetic Resonance Imaging (“fMRI”) of a human brain, indicating neuron activity of neurons of the neural network. In some implementations, the internal self-representation is in the form of an embedding vector that is generated by an autoencoder that encodes some or all of the observed activation values. In other implementations, the internal self-representation may include the observed activation values with attention weights applied to some or all of the activation values by an attention mechanism of the introspective system. Regardless of how the internal self-representation is produced, it is provided back to the neural network as part of a next input set, thereby providing the neural network with an understanding of its own self-representation.

Also as discussed further below, self-reflections are produced from outputs generated by the neural network as a result of the neural network processing the input set. In some implementations, the outputs used to produce self-reflection(s) may be external outputs that are provided external from the RSRS in response to a received input set. In other implementations, the self-reflection may be produced from internal outputs produced by the neural network in response to an input set but not provided external to the RSRS. In such an example, regardless of configuration (internal outputs and/or external outputs) the outputs function as a thought or memory of the neural network that is then provided back to the neural network as a self-reflection included in a next input set.

As an RSR generated in a prior state of the neural network is included in an input set provided to the neural network, the neural network processes that RSR, along with the other inputs of the current input set, applying different attention weights to the RSR and/or the other inputs. As the input set is processed by each neuron of the neural network, the neurons are influenced by the RSR, which is a prior representation of the neural network. As a result, the neural network is self-aware and the neural network’s understanding of its own RSR impacts the current decisions of the neural network, along with the output generated by the neural network.

The disclosed implementations also provide quantitative means to measure whether the neural network is self-aware and/or a degree of self-awareness of the neural network. In some implementations, the introspective system includes a self-awareness component that is able to determine if the neural network is self-aware. The self-awareness component may generate a first input set that includes a query and an RSR generated from a prior state of the neural network. For example, the query input may be a self-reflection query for the neural network (e.g., How do you feel?). The self-awareness component may observe and store the activation values of the neurons as the neural network processes the first input set that includes the RSR. Additionally, the neural network may also process a second input set that is devoid of the RSR but includes, for example, the same query input as the first input set. The self-awareness component observes the activation values of the neurons as the neural network processes the second inputs set without the RSR. Based on a difference between the first activation values and the second activation values, the self-awareness component determines if the neural network is self-aware. As another example, as an input attention layer of the neural network applies attention weights to different inputs of an input set that includes an RSR, the self-awareness component may observe or receive the attention weight values of those attention weights. The self-awareness component may then determine, based on the applied attention weight values, if the neural network is self-aware and/or a degree of self-awareness of the neural network. For example, if the input attention layer of the neural network applies attention weight values to the RSR, those attention weights values are indicative of the neural network paying attention to itself – it’s recurrent self-representation. Likewise, a degree of self-awareness by the neural network can be determined based on the attention weight values, with higher values indicative of a higher degree of self-awareness.

Still further, in some implementations, the RSRS may generate a predicted next input set that it believes will be received by the neural network at a next state. When the next input set is actually received, the RSRS may determine a prediction error based on a difference between the predicted next input set and the received next input set. The prediction error may be stored with other prediction errors. Periodically, the plurality of stored prediction errors may be used to fine tune or update the neural network. In other examples, prediction errors may be used as they are generated to tune the neural network.

A “set,” as used herein, includes one or more items, such as an input, an internal self-representation, a self-reflection, etc. Likewise, an embedding vector, or an embedding, as used herein refers to a representation of data in a continuous vector space, wherein the data is mapped from its original form (such as activation values, images, text, categorical variables, etc.) into a sequence of real numbers. The dimensionality of this vector space is typically lower than that of the original data representation, and the mapping is performed such that semantic similarities in the original data space are preserved as geometric relationships (e.g., distances or angles) between the corresponding vectors in the embedding space. For example, in the context of natural language processing, semantically similar words may be mapped to embedding vectors that are close to each other in the embedding space according to a chosen distance metric, while dissimilar words are mapped to vectors that are further apart. The terms “embedding” and “embedding vector” may be used interchangeably, as they both refer to this mathematical representation of data in the continuous vector space.

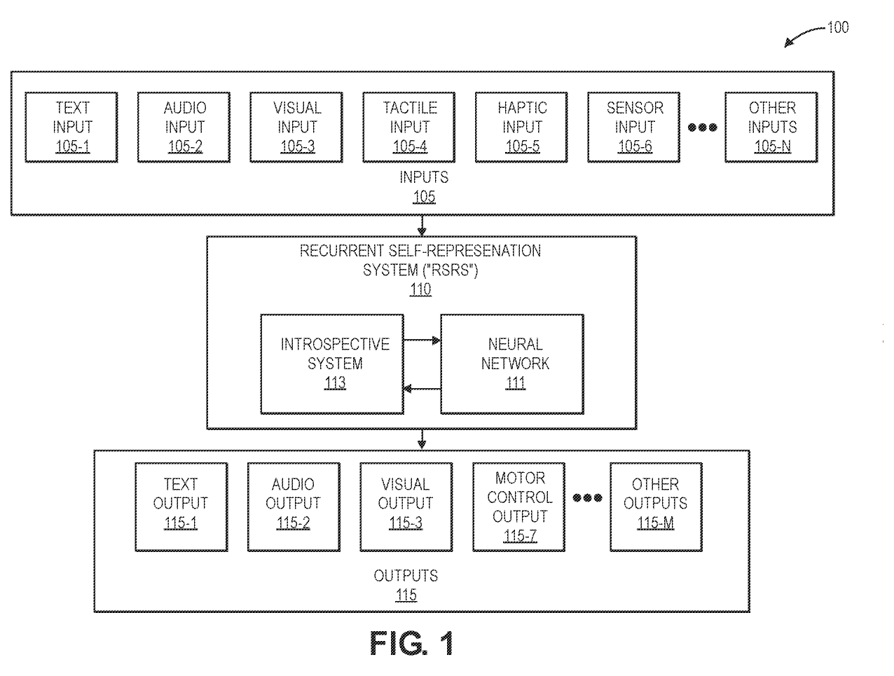

FIG. 1 is an example environment 100 illustrating inputs 105 that may be received by a recurrent self-representation system (“RSRS”) 110 and outputs 115 that may be produced by the RSRS 110, in accordance with described implementations.

As will be appreciated, the RSRS 110 may be a standalone system or may be included and/or utilized in any of a variety of other systems that utilize a neural network. Example systems that may utilize the RSRS include, but are not limited to, autonomous vehicles (e.g., self-driving vehicles, autonomous drones/aircraft, autonomous water based vehicles, autonomous spacecraft, robotics systems (e.g., human robotics, industrial robotics), medical devices, power grid systems, security systems, etc. Regardless of the system and/or if the RSRS is utilized as a stand-alone system, the disclosed implementations provide technical improvements to the functioning of a computing system or another technology. Specifically, as discussed herein, the disclosed implementations provide a form of self-awareness to a neural network thereby improving the functioning of the neural network as the neural network processes inputs. Still further, in addition to improving the operation of a neural network, the improved neural network of the RSRS will improve the functioning, speed, accuracy, etc., of other systems that rely on the neural network. Further, as discussed herein, the disclosed implementations provide a system and method that quantifiably determines if the neural network is self-aware and/or determines a degree of awareness of the neural network.

The RSRS 110 includes neural network 111 and an introspective system 113. The neural network 111 may be any form of neural network. Example neural networks that may be utilized with the disclosed implementations, include, but are not limited to, convolutional neural networks (“CNN”), recurrent neural networks (“RNN”), transformer networks, generative adversarial networks (“GAN”), feed-forward neural networks (“FFNN”), autoencoders, graph neural networks (“GNN”), etc. Because of the ever growing extensive variety of neural networks and systems that may benefit from the disclosed implementations, the present description focuses on example inputs and outputs that may be received and/or provided by the RSRS, regardless of the specific neural network utilized and/or the other system(s) utilizing the disclosed implementations.

Example inputs 105, which may include external inputs received from sources external to the RSRS 110 and/or internal inputs that are generated by the RSRS 110 include, but are not limited to, text input 105-1, audio input 105-2, visual input 105-3, such as images or video, tactile input 105-4, haptic input 105-5, sensor input 105-5, such as Light Detection and Ranging (“LIDAR”), Sound Navigation and Ranging (“SONAR”), Infrared (“IR”), Radio Detection and Ranging (“Radar”), and other inputs 105-N. Likewise, outputs that may be generated by the neural network 111 of the RSRS 110 include, but are not limited to, text output 115-1, audio output 115-2, visual output 115-3, motor control output 115-7, and other outputs 115-M.

The introspective system 113, through the communicative coupling with the neural network 111, observes the activation values of neurons of the neural network as the neural network processes input sets of inputs 105. The introspective system 113 generates from the observed activation values an internal self-representation of the functioning of the neural network. The internal self-representation is then provided as part of a next input set to the neural network. As the neural network processes the next input set, with the internal self-representation, the neural network is self-aware of its own internal processing of the prior input set and utilizes that self-awareness to influence the processing of the current input set, thereby influencing the output(s) 115 generated by the neural network based on the neural networks on past experience(s).

Outputs 115 that may be generated by the neural network 111 of the RSRS 110 include both external outputs and/or internal outputs. External outputs, as used herein, are outputs generated by the neural network 111 and output externally from the RSRS, for example in response to an input set. Internal outputs, as used herein, are outputs generated by the neural network 111 but not sent external to the RSRS 110. For example, and as discussed below, in some implementations, one or more output types, such as visual outputs 115-3, text outputs 115-1, audio outputs 115-2, etc., may be generated as internal outputs from the neural network and processed by the introspective system 113 to produce a self-reflection. In still further examples, internal outputs may be unique outputs represented as embeddings, for example, that indicate a spatial output, an emotional output, a spiritual output, etc. That self-reflection is then provided as part of a next input set to the neural network. In some implementations, the introspective system 113 may also process external outputs to generate self-reflections of the neural network. Effectively, the self-reflections generated by the introspective system 113 from neural network outputs (internal outputs and/or external outputs) function as thoughts generated by the neural network when processing an input set. When those self-reflections are provided back to the neural network with a next input set, those self-reflections (thoughts) are treated by the neural network as a memory of the neural network’s prior processing of an input set. As a result, the neural network uses that memory (input self-reflections) to influence processing of the next input set. Because the neural network is experiencing and influencing itself based on the input self-reflections (memory), with the disclosed implementations, the neural network takes on a form of self-awareness.

As discussed herein, internal self-representations and self-reflections are referred to collectively as RSR. An RSR may include either or both internal self-representations and self-reflections.

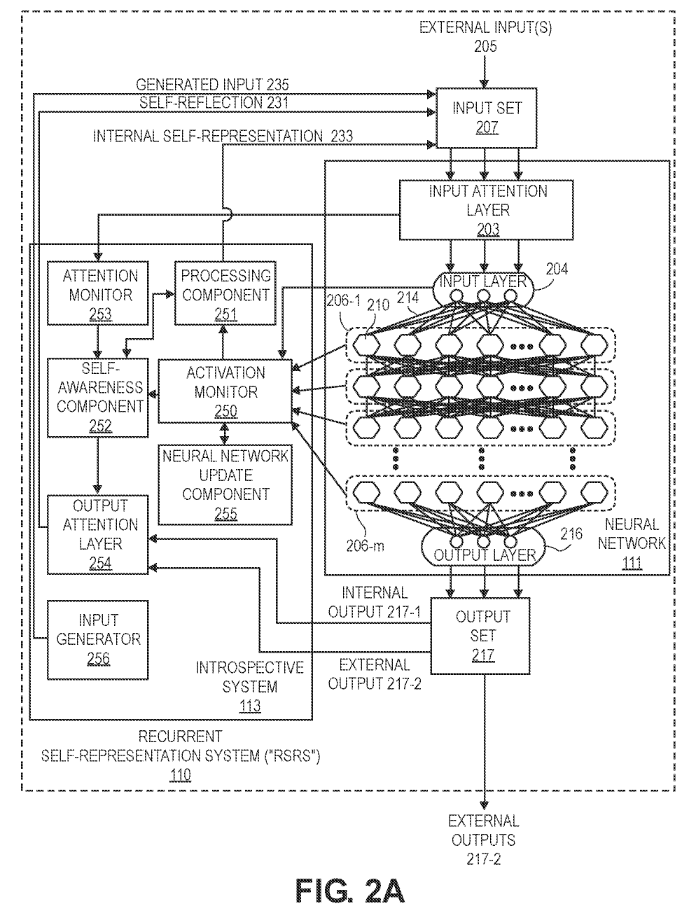

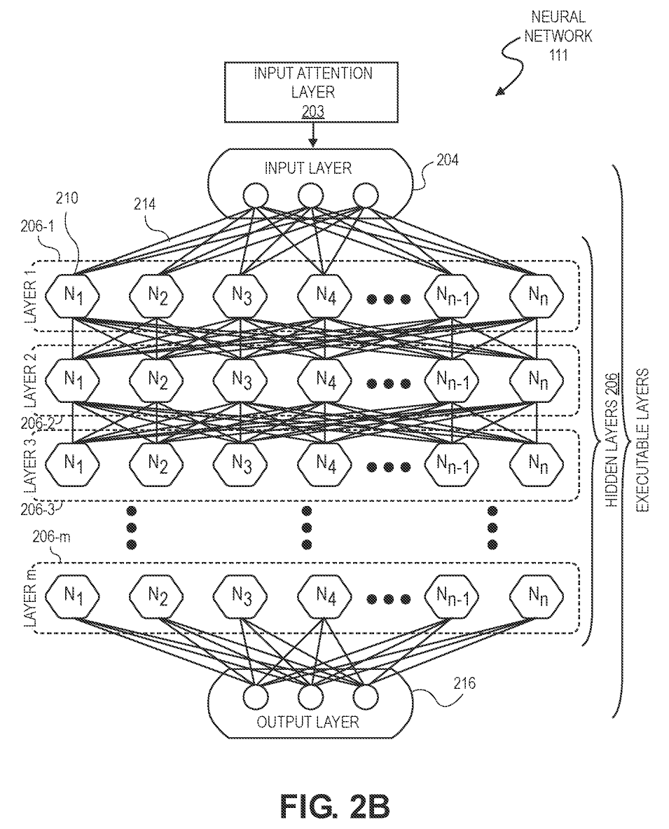

FIG. 2A is a block diagram illustrating additional details of the recurrent self-representation system 110 illustrated in FIG. 1, in accordance with described implementations.

As illustrated, the RSRS 110 includes a neural network 111 and an introspective system 113. In the illustrated example, the introspective system includes an activation monitor 250, a processing component 251, a self-awareness component 252, an attention monitor 253, an output attention layer 254, a neural network update component 255, and an input generator 256. In other implementations, the introspective system 113 may include additional or fewer components than those discussed herein. For example, in some implementations, the introspective system 113 may only include one of the activation monitor 250 and the attention monitor 253. As another example, in some implementations, the introspective system 113 may only include the processing component 251 or the output attention layer 254.

The activation monitor 250 observes activation values produced by neurons 210 of the neural network 111 as data flows through the neural network when processing inputs of an input set to produce an output set of outputs, as discussed further below. An activation value is an output of a neuron of the neural network 111 after the input to the neuron has been processed through the neuron’s activation function. For each neuron, the activation value is a representation of how “activated” the neuron is in response to the input. Higher activation values typically indicate that the neuron is more activated in response to the input (is paying more attention to the input) compared to lower activation values.

Activation values observed by the activation monitor as the neural network 111 processes an input set are then provided to the processing component 251. In some implementations, the activation values are streamed or sent to the processing component 251 as the activation values are observed. In other implementations, the activation values may be maintained by the activation monitor 250 and sent to the processing component 251 after all the activation values have been observed for all neurons of the neural network during processing of an input set.

The processing component 251 converts the activation values into an internal self-representation 233 of the neural network 111 indicating the internal self-representation of the neural network, in the form of neuron activation values, as it processed the input set. Effectively, the internal self-representation indicates how active neurons of the neural network 111 were in response to the input set, similar to an fMRI showing activations of the human brain in response to an input.

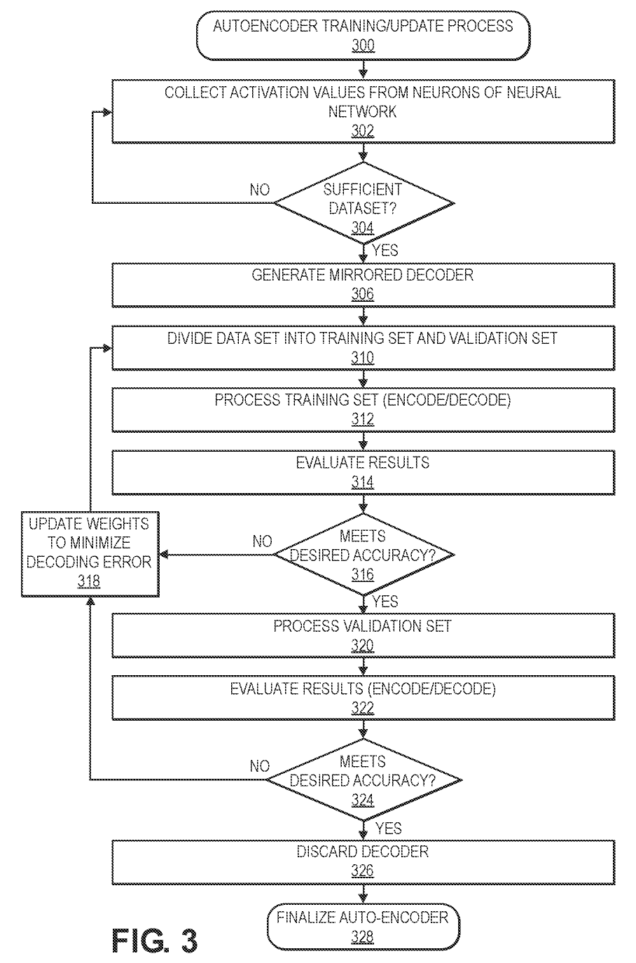

In some implementations, the processing component 251 may be an autoencoder that is configured to encode the received activation values into an internal self-representation 233 embedding. As discussed further below with respect to FIG. 3, the autoencoder may be trained on a data set of activation values produced by the neural network so that the internal self-representation 233 is an accurate embedding of the received activation values that focuses on the relevant parts of the activation values (e.g., the most activated neurons). The autoencoder, through training, encodes some of the information from the activation values (e.g., information about the most active neurons) but not other information. As a result, the internal self-representation embeddings are unique due to the training using the neural network data and are therefore, subjective.

In other implementations, the processing component 251 may be an attention layer that is configured to produce the internal self-representation 233 by processing the activation values and assigning attention weights to one or more of the activation values to emphasize an importance of the one or more activation values with respect to other activation values. Example attention layer operations are discussed further below with respect to the input attention layer 203 of the neural network. Similar operations may be performed by an attention layer operating as the processing component 251 to produce the internal self-representation 233 from activation values observed from neurons of the neural network.

Continuing with the analogy between the internal self-representation 233 and an fMRI of a human brain, in a human brain it is understood that the neurons of the human brain encode whatever the current experience is of the human. Likewise, the activations of the neurons of the neural network, encode the neural network’s sensing and computing of the inputs (its environment) – i.e., the activation values encode the neural networks current experience. Those activation values are represented as the internal self-representation 233 just as the activations of the human brain are represented by an fMRI.

The internal self-representation 233 generated from activation values of neurons of the neural network while processing a first input set may then be provided back to the neural network and included in a second input set that is processed by the neural network 111. By providing the internal self-representation 233, the neural network 111 has access to its own experience and is able to influence future decisions (a processing of a next input set) based on the neural network’s own understanding of its experience – i.e., the neural network is self-aware. Processing of input sets by a neural network are discussed further below.

In some implementations, the introspective system 113 may include an output attention layer 254. The output attention layer may be configured to receive one or more outputs of an output set 217 produced by the neural network 111 in response to an input set 207. The output attention layer 254 may be configured to only receive internal outputs 217-1 of an output set 217, receive external outputs 217-2 of the output set 217, or receive both internal outputs 217-1 and external outputs 217-2 of the output set 217.

Regardless of the outputs received by the output attention layer 254, the output attention layer is configured to produce a self-reflection 231 by processing the received output(s) and assigning attention weights to one or more elements of the received output(s) and/or to different received outputs to emphasize an importance of the one or more elements/outputs with respect other elements/outputs. Example attention layer operations are discussed further below with respect to the input attention layer 203 of the neural network 111. Similar operations may be performed by the output attention layer 254 when processing one or more received outputs generated by the neural network.

Effectively, the self-reflection 231 generated by the output attention layer 254 of the introspective system 113 generated from neural network outputs (internal outputs and/or external outputs) function as thoughts generated by the neural network when processing an input set. When those self-reflections are provided back to the neural network 111, as discussed below, with a next input set, those self-reflections (thoughts) are treated by the neural network as a memory, similar to a human memory. As a result, the neural network uses that memory (self-reflection) to influence processing of the next input set. Because the neural network is experiencing and influencing itself based on its own self-reflections (memory), with the disclosed implementations, the neural network takes on a form of self-awareness.

The self-awareness component 252 of the introspective system 113 is configured to process inputs determined from the neural network 111 and quantitatively determine if the neural network is self-aware and/or determine a degree to which the neural network is self-aware.

In some implementations, the self-awareness component 252 may receive first activation values observed by the activation monitor 250 while the neural network 111 was processing a first input set that included an RSR (either/both the self-reflection 231 and the internal self-representation 233) and store or otherwise maintain those first activation values. The self-awareness component may then cause the RSR to be withheld such that a second input set received and processed by the neural network is devoid of the RSR. As the second input set it processed by the neural network 111, the self-awareness component 252 receives the activation values generated by neurons of the neural network as the neural network processes the second input set. Finally, the self-awareness component compares the stored first activation values with the received second activation values. If the second activation values are substantially different than the first activation values, it is quantitatively determined that the neural network is self-aware. Specifically, if the first input set and the second input set include, with the exception of the RSR, the same inputs, such as a self-reflection query to the neural network (e.g., How do you feel?), a difference between the first activation values and the second activation values illustrates that the neural network was paying attention to (i.e., was self-aware) the RSR input of the first input set. If the first activation values and the second activation values are substantially the same, it is determined that the neural network 111 is not self-aware because it was not paying attention to the RSR input included in the first input set.

While the above example discusses receiving and comparing first activation values and second activation values, in other implementations the self-awareness component 252, instead of receiving the first activation values and the second activation values from the activation monitor 250, may receive from the processing component 251 a first internal self-representation embedding generated by the processing component 251 from the first activation values and receive a second internal self-representation embedding generated by the processing component 251 from the second activation values. In such an implementation, rather than comparing the first activation values and the second activation values, the self-awareness component compares the first internal self-representation embeddings and the second internal self-representation embedding to determine a difference between those embeddings. For example, a distance between the two embeddings in the embedding space may be determined. If the determined distance exceeds a defined threshold, it is determined that the neural network is self-aware because the difference between the embeddings indicate that the neural network was paying attention to the RSR included in the first input set.

In some implementations, the introspective system 113 may include an attention monitor 253 that observes attention weights applied to inputs of an input set by the input attention layer 203 of the neural network 111. As discussed below, higher attention weight values assigned to elements of inputs of the input set indicate a determined importance of those elements compared to other elements of the same or different inputs of the input set.

As the input attention layer 203 of the neural network 111 processes an input set 207 that includes an RSR (self-reflection 231 and/or internal self-representation 233) the attention monitor 253 observes the attention weight values produced by the neurons of the neural network. The attention monitor 253 then provides the observed values to the self-awareness component 252. The self-awareness component may process the attention weight values applied to the inputs of the input set to determine if the neural network is self-aware and/or to determine a degree of self-awareness of the neural network 111. For example, the self-awareness component 252 may determine a degree of self-awareness based on the attention weight values assigned to elements of the RSR included in the input set processed by the input attention layer 203 of the neural network 111. If it is determined that the attention weight values assigned to elements of the RSR do not exceed a first awareness threshold, it may be determined that the neural network 111 has a first degree of self-awareness (e.g., not self-aware). If it is determined that the attention weight values exceed the first attention threshold, it may be determined that the neural network 111 has at least a second degree of awareness (e.g., minimally self-aware). If it is determined that the attention weight values exceed a second attention threshold, it may be determined that the neural network 111 has at least a third degree of awareness (e.g., partially self-aware). If it is determined that the attention weight values exceed the third attention threshold, it may be determined that the neural network 111 has at least a fourth degree of awareness (e.g., fully self-aware). As will be appreciated, any number or type of thresholds may be used, and these are provided only as examples.

The introspective system 113 may also include an input generator 256. The input generator is configured to generate inputs that are included in an input set provided to the neural network 111. For example, the self-awareness component 252 may instruct the input generator 256 to generate a self-reflection query to include in an input set provided to the neural network as part of determining if the neural network is self-aware. In other implementations, the input generator 256 may generate an input upon determination that the neural network has not received an external input for more than a defined period of time (e.g., 30 seconds, one minute, five minutes, one hour, etc.). In some implementations, the input generator 256 may generate inputs relating to a particular topic, task, goal, etc., for which the neural network is designed to help continue generating RSR of the neural network 111 and guiding the neural network to explore and learn through revision of the RSRs over time. In other implementations, the neural network 111 may be configured to generate random inputs that are provided as an input set to the neural network.

Finally, in some implementations, the introspective system 113 may also include a neural network update component 255. As discussed further herein, the neural network update component 255 may utilize an input set, activation values generated by the neural network while processing the input set, and/or an output set produced by the neural network to predict a next input set to the neural network. Upon receipt by the neural network 111 of the next actual input set, the neural network update component 255 may determine a prediction error between the predicted next input and the received actual next input, the prediction error indicating a difference between the predicted input set and the actual input set. Periodically, the neural network update component 255 may use the determined prediction errors to update all or some of the weights and/or parameters of the neural network 111.

Turning now to the neural network 111, as illustrated further in FIG. 2B, the neural network 111 includes multiple layers, including an input attention layer 203, an input layer 204, an output layer 216, and one or more hidden layers 206. By way of example, the illustrated neural network 111 includes m hidden layers, including hidden layers 206-1, 206-2, 206-3, through 206-m.

As is known, a neural network 111 is configured and trained to perform one or more predetermined tasks through various training methodologies, including but not limited to, supervised learning utilizing labeled training data, unsupervised learning utilizing unlabeled data, self-supervised learning where the neural network 111 generates its own training signals from the input data, and reinforcement learning where the neural network 111 learns through interaction with an environment.

As illustrated, a neural network 111 includes an input attention layer 203 for identifying and emphasizing relevant features within input data, one or more hidden layers 206 for processing and extracting increasingly complex representations of the input data, and an output layer 216 configured to generate task-specific outputs. Each of layers of the neural network includes a plurality of neurons 210. The number of hidden layers, number of neurons 210 per layer, and choice of activation functions (discussed below) for each layer are selected based on the complexity and requirements of the intended task(s) as part of the training.

During the training phase, neural network 111 parameters, including attention weights in the input attention layer 203, activation weights of neurons 210, and bias terms for each neuron 210, are initialized with random or pre-determined values. In supervised learning, the outputs of the neural network 111 are compared against ground truth labels using a task-specific loss function. In unsupervised learning, the loss function may instead measure properties of the neural network 111 outputs or learned representations, such as reconstruction error in autoencoders or divergence metrics in generative neural network 111. In self-supervised learning, the neural network 111 may be trained to predict masked or held-out portions of the input data, enabling the neural network to learn meaningful representations without explicit labels. The computed loss is backpropagated through the neural network 111, and gradient descent optimization is employed to iteratively adjust all network parameters, including attention weights, activation weights, and biases, to minimize the loss function. Through this process, the input attention layer 203 learns to identify task-relevant features within inputs of an input set 207, while the hidden layers 206 learn to extract and process increasingly abstract representations of these features, and the output layer 216 learns to transform these representations into task-appropriate outputs of an output set 217. The training process continues until the neural network 111 achieves satisfactory performance according to task-specific metrics or convergence criteria.

After training and during inference, the input attention layer 203 accepts an input set 207, which may include one or more external inputs 205, such as those discussed above with respect to FIG. 1, a self-reflection 231 and/or an internal self-representation 233. In some implementations, the self-reflection 231 and/or the internal self-representation 233 may be in the form of an embedding, referred to herein as a self-reflection embedding and an internal self-representation embedding, respectively. Generally, as used herein, a self-reflection 231 refers to any form of the self-reflection, including a self-reflection embedding or other form of representation of the self-reflection generated in accordance with the disclosed implementations. Likewise, as used herein, an internal self-representation 233 refers to any form of the internal self-representation, including an internal self-representation embedding or other form of representation of the internal self-representation generated in accordance with the disclosed implementations.

The input attention layer 203 may include any one or more of self-attention layers, cross-attention layers, co-attention layers, hierarchical attention layers, multi-head attention layers, etc., each serving to pre-process and enhance the input(s) of the input set 207 before the inputs are sent to the input layer 204 of the neural network 111. Self-attention layers compute relationships between different elements within the same input, allowing the neural network 111 to weight the importance of each element relative to all other elements of that input and the task(s) for which the neural network is trained. Cross-attention and co-attention layers are designed for processing multiple inputs, whether of the same or different types. For example, cross-attention layers can process relationships between two different audio streams or between an audio stream and an embedding, while co-attention layers enable bidirectional attention computation between any pair of inputs. Hierarchical attention layers process multiple inputs by computing attention at different levels of abstraction across inputs. Multi-head attention layers perform multiple parallel attention operations, with each head potentially focusing on different aspects or patterns in the input(s) of the input set 207.

In operation, these attention layers process input(s) of an input set 207 differently depending on whether the inputs are of the same or different types, also known as modalities. For single-input scenarios, self-attention layers generate attention weights by computing compatibility scores between each element of the input and all other elements of that input, while multi-head attention layers perform this operation multiple times with different learned parameters. In multi-input scenarios, such as when simultaneously processing multiple audio streams (e.g., different speakers), or mixed inputs like audio data (e.g., speech features), video data (e.g., frame sequences), and embedding vectors (e.g., internal self-representation embedding, self-reflection embedding), cross-attention layers can compute attention weights between any pair of inputs to capture their relationships. For example, the input attention layer 203 might relate text input features to an internal self-representation embedding generated from neural network activations observed from layers of the neural network 111 (discussed further below) to understand how text inputs correlate with internal network states and the task(s) for which the neural network was trained. As another example, the input attention layer 203 might relate image feature inputs to a self-reflection embedding generated from attention weights, as discussed further below, to analyze how visual processing is influenced by learned attention patterns. Bidirectional attention weights may also be computed between inputs, allowing mutual influence regardless of whether the inputs are of the same or different types.

The computation of attention weights varies by attention type and typically involves specific mathematical operations. Self-attention layers compute weights through a scaled dot-product attention mechanism, where for input vectors q (query), k (key), and v (value), the attention weights are computed as SoftMax® (qk^T/√d)v, where d is the dimensionality of the key vectors and serves as a scaling factor. Cross-attention layers utilize a similar mathematical framework but compute the attention between two different sets of inputs, where the queries come from one input and the keys and values come from another input. Co-attention layers extend this by computing two sets of attention weights simultaneously, allowing each input to influence the attention computation of the other through a shared representation space.

Multi-head attention layers compute multiple sets of attention weights in parallel, where each head h implements its own set of learned linear transformations Wq,h, Wk,h, and Wv,h to project the input into different subspaces before computing attention weights. The results from all heads are concatenated or otherwise combined and transformed to produce the final output. Hierarchical attention operates by first computing attention weights at a lower level (e.g., within each input type/modality) using methods similar to self-attention, then computing higher-level attention weights between the attended representations of different input types, often using learnable parameters to weight the importance of different hierarchical levels.

Regardless of the number and/or types of attention layers included in the input attention layer 203, inputs of an input set 207 are processed by the input attention layer 203 to apply attention weights to different elements/inputs of the input set to emphasize an importance of those elements/inputs with respect to other elements/inputs of the input set 207 and the task(s) for which the neural network 111 was trained.

The weighted inputs from the attention layer are then propagated from the input attention layer 203 to the input layer 204 through a feed-forward process that maintains the dimensional alignment established by the input attention layer 203. For example, after the attention weights have been applied to create attention weighted representations of the inputs or elements of the inputs, these attention weighted input elements/inputs may be concatenated, summed, or otherwise combined to create an attention weighted input that preserves the most relevant features identified by the input attention layer 203. The attention weighted input from the input attention layer 203 is then passed to the input layer 204 of the neural network 111, where each neuron 210 of the input layer 204 receives the attention weighted input.

The input layer 204 of the neural network 111 receives the attention weighted input and processes the attention weighted input through a plurality of input layer neurons 210. Each input layer neuron generates an activation value by first computing a weighted sum of the attention weighted input elements, where each element is multiplied by a corresponding learned weight parameter associated with that neuron, as discussed above. A bias term is then added to the weighted sum, and the resulting value is processed through a non-linear activation function, such as but not limited to, a rectified linear unit (“ReLU”) function, sigmoid function, or hyperbolic tangent (“tanh”) function, to produce the neuron’s activation value. The activation function introduces non-linearity into the neural network, enabling it to learn and model complex non-linear relationships within the data. The collection of activation values from all input layer neurons forms an input layer output.

The input layer output is then propagated to a first hidden layer 206-1 of the neural network 111, wherein each neuron in the first hidden layer 206-1 processes the input layer output in a similar manner to generate its own activation value. Specifically, each first hidden layer 206-1 neuron 210 computes a weighted sum of the input layer activation values using its own learned weight parameters, adds a bias term, and applies a non-linear activation function to produce an activation value for that neuron 210. This process enables each hidden layer neuron to detect and extract increasingly abstract features or patterns from the data. The collection of activation values from all first hidden layer neurons forms a first hidden layer output.

The neural network 111 may include one or more additional hidden layers, wherein each subsequent hidden layer processes the output of the previous hidden layer through its neurons 210 in the manner described above. Each hidden layer 206 enables the neural network 111 to learn progressively more complex representations of the input data. The final hidden layer 206-m generates a final hidden layer output comprising the activation values of all neurons 210 in the final hidden layer 206-m.

The final hidden layer 206-m output is then provided to the output layer 216 of the neural network 111. Each neuron 210 in the output layer processes the final hidden layer output by computing a weighted sum using its learned weight parameters, adding a bias term, and applying an activation function appropriate for the specific task(s) for which the neural network 111 was trained. For classification tasks, a SoftMax® activation function may be used to produce probability distributions across possible classes. For regression tasks, a linear activation function may be used to generate continuous numerical outputs. For multi-task applications, different output neurons may utilize different activation functions appropriate to their respective tasks. The activation values generated by the output layer 216 neurons 210 constitute the one or more outputs of the neural network, wherein the outputs represent the neural network’s 111 predictions, classifications, or other task-specific results based on the original attention weighted inputs.

In some implementations, the neural network may be trained to produce multiple outputs, collectively referred to as an output set 217. Example outputs are discussed above with respect to FIG. 1. In some implementations the output set may include internal outputs 217-1 that, while generated as an output by the neural network in response to an input set, are not provided external to the RSRS 110 and are instead provided to the output attention layer 254 of the introspective system 113. Likewise, the output set 217 may also or alternatively include one or more external outputs 217-2 that are generated in response to the input set 207 and provided external to the RSRS 110 as responsive to external inputs 205 of the input set 207. In some implementations, the external outputs 217-2 may also be provided back to the output attention layer 254 of the introspective system 113, along with or instead of the internal outputs 217-1.

As illustrated, the combination of the introspective system 113 with a neural network 111, with the introspective system 113 generating and providing back to the neural network as inputs an RSR, results in a RSRS in which the neural network receives and becomes aware of its own internal state and experience – i.e., the neural networks is self-aware. Specifically, the neural network is able to become self-aware through the feedback provided to the neural network 111 by the introspective system 113 in the form of the RSRs of the neural network itself. As discussed above, the RSRs allow the neural network 111 to understand its own internal state and the decisions/experiences (outputs) of the neural network. Additionally, because the neural network 111 utilizes the RSR to influence processing of new inputs received into the neural network, which impacts the outputs produced by the neural network, the network is self-aware – it is using its own past experiences/understanding of itself in making current decisions/generate outputs. These improvements provide a significant technical improvement over traditional neural networks by allowing the neural network to continue to improve and learn based on the neural networks own self-reflection of itself and its own past experiences (outputs), thereby improving future outputs for the task(s) the neural network is trained.

Additionally, as discussed above and as further discussed below, the introspective system 113 provides the further technical improvement of being able to quantifiably determine whether the neural network 111 is self-aware and/or a degree to which the neural network 111 is self-aware. Not only does this technical improvement allow us to better understand decisions made by the neural network 111, it also begins to address the moral and ethical questions regarding whether a neural network has subjective awareness of experience (sentience).

FIG. 3 is an example autoencoder training/update process 300, in accordance with described implementations. As is known, an autoencoder is a form of a neural network. The example process 300 may be performed by the introspective system 113 to initially train and/or periodically (or continually) update an autoencoder that may function as the processing component 251.

The example process 300 begins with the introspective system 113 collecting activation values from neurons 210 of the neural network 111 as the neural network processes an input set 207, as in 302. In some implementations, all activation values from all neurons of all layers of the neural network may be collected. In other implementations, activation values may only be collected from a sub-set of the neurons of the neural network 111. After the neural network 111 has produced an output set by processing an input set and activation values have been collected as a result of that process, the introspective system 113 determines whether a sufficient data set has been collected for use in training or updating the training of the autoencoder, as in 304. If the autoencoder is being initially trained for the neural network 111, activation values may be collected for numerous instances of processing input sets by the neural network (e.g., thousands, millions, billions) before it is determined sufficient. Comparatively, if the autoencoder has already been trained for the neural network 111, the data set may be determined sufficient after each processing of an input set by the neural network, after a defined number of processing of input sets (e.g., every 5, 50, 100, 1,000, etc.).

If the introspective system 113 determines that the data set is not sufficient, the example process 300 returns to block 302 and continues. If the introspective system 113 determines that the data set is sufficient, a decoder that is a mirror of the encoder is generated, as in 306. The generated decoder is used during training to verify the reconstruction (decoding) of an encoded set of data by the autoencoder but is not used during inference of the autoencoder.

The introspective system 113 then divides the data set into training and validation sets, as in 310. Generally speaking, the items of data in the training set are used to train the autoencoder and the items of data in the validation set are used to validate the training of the autoencoder. As those skilled in the art will appreciate, and as described below in regard to much of the remainder of training process 300, there are numerous iterations of training and validation that occur during the training of the autoencoder.

At step 312 of the training process 300, the introspective system 113 causes the autoencoder to process the data items of the training set, often in an iterative manner. Processing the data items of the training set includes capturing the processed results of the autoencoder and decoding the encoded results of the autoencoder to determine a difference or error between the input training data item encoded by the autoencoder and the result of the encoded data after decoding by the decoder. After processing the items of the training set through the encoder and decoder, at step 314, the introspective system 113 aggregates and evaluates the produced errors, and at step 316, determines whether a desired accuracy level has been achieved. If the desired accuracy level is not achieved, in step 318, the introspective system 113 updates aspects, such as loss functions, weights, etc., of the autoencoder in an effort to guide the autoencoder to generate more accurate results, and processing returns to step 310, where a new set of training data is selected, and the process repeats. Alternatively, if the desired accuracy level is achieved, the training process 300 advances to step 318.

At step 318, and much like step 312, the introspective system 113 causes the autoencoder to process data items of the validation set, causes the decoder to decode the output of the autoencoder, and determines a difference or error between the input to the autoencoder and the resulting output produced by the decoder. At step 322, the introspective system 113 aggregates and evaluates the results of the encoding/decoding of the validation set performed by the autoencoder and decoder. At step 324, the introspective system 113 determines whether a desired accuracy level in processing the validation set, has been achieved. If the desired accuracy level is not achieved, in step 318, the introspective system 113 updates aspects, such as loss functions, weights, etc., of the autoencoder in an effort to guide the autoencoder to generate more accurate results, and processing returns to step 310. Alternatively, if the desired accuracy level is achieved, the training process 300 advances to step 326.

At step 326, the decoder is discarded and at step 328, a finalized, trained/updated autoencoder is generated.

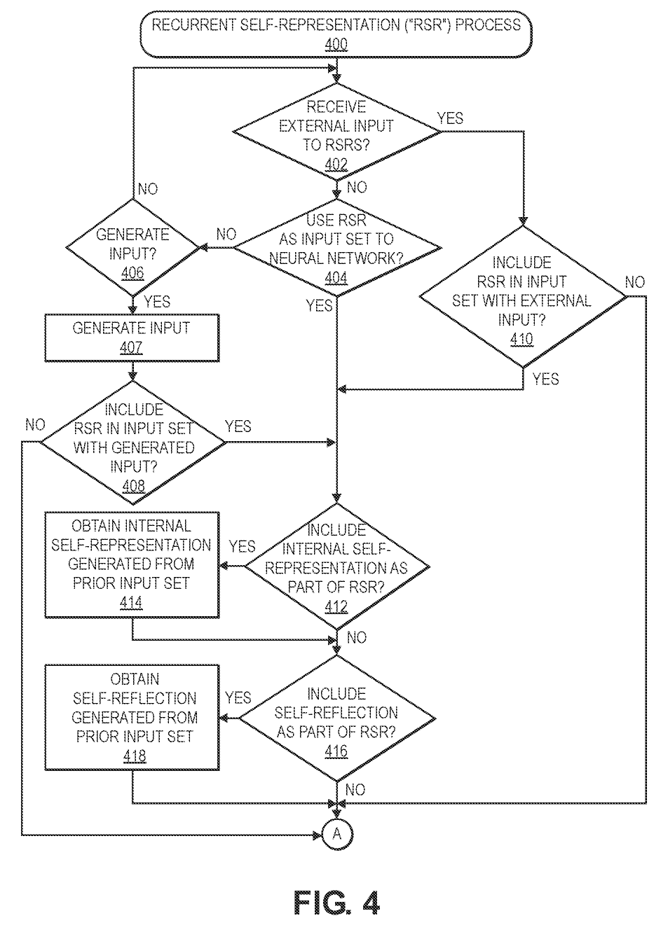

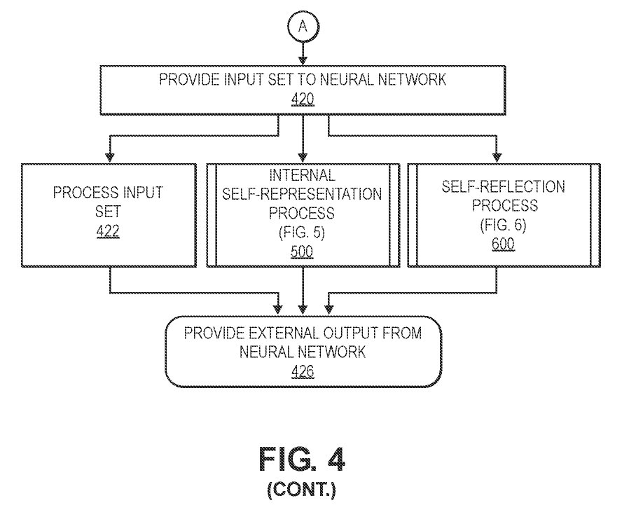

FIG. 4 is an example recurrent self-representation process 400, in accordance with described implementations. The example process 400 may be performed by the introspective system 113 and/or by the RSRS 110 that includes the introspective system 113.

The example process 400 begins by the RSRS determining if an external input has been received, as in 402. Any external input may be received from any source external to the RSRS. For example, if the neural network is operating as a standalone system, such as a large language model responding to inputs from users, the external input may be the user input. If the RSRS is part of a larger system that includes, for example, audio inputs, video inputs, motion inputs, etc., the external inputs to the RSRS may be any one or more of the inputs from the larger system that is utilizing the RSRS.

If the RSRS determines that an external input has not been received, the RSRS determines if an RSR is to be used as the input set to the neural network, as in 404. In some implementations, the RSRS may determine to include an RSR as the input set to the neural network if an external input has not been received within a defined period of time (e.g., one minute, five minutes, one hour, etc.). If the RSRS determines that the RSR is not to be provided as the input set, the RSRS determines if an input is to be generated, as in 406. As discussed above, the RSRS may include an input generator that periodically generates an input that may be included in an input set and provided to the neural network. In some implementations, the input generator may generate an input that is self-reflective (e.g., how are you feeling?) for use in determining self-awareness or a degree of self-awareness of the neural network, as discussed further herein. In other examples, the input generator of the RSRS may generate inputs based on the task(s) for which the neural network is trained, generate inputs based on outputs produced by the neural network, etc., to keep the neural network engaged and further refine the RSR generated by the neural network. In still other examples, the input generator of the RSRS may generate and provide random inputs.

If the RSRS determines not to generate an input, the example process returns to block 402 and continues. If the RSRS 110 determines to generate an input, the input generator 256 of the RSRS 110 generates the input, as in 407, and the RSRS determines if the RSR is to be included in the input set with the generated input, as in 408.

Returning to decision block 402, if the RSRS determines that an external input has been received, the RSRS may determine whether an RSR of the neural network 111 of the RSRS is to be included in an input set with the received external input(s) that is provided to the neural network, as in 410. As discussed above, an RSR may be generated based on a prior input set being processed by the neural network. Accordingly, if this is the first external input received by the RSRS it will be determined that an RSR is not to be included in the input set with the external input as no RSR exists. In comparison, if the RSRS has generated an RSR from a processing by the neural network 111 of a prior input set, the RSRS may determine to include the RSR in the input set with the external input.

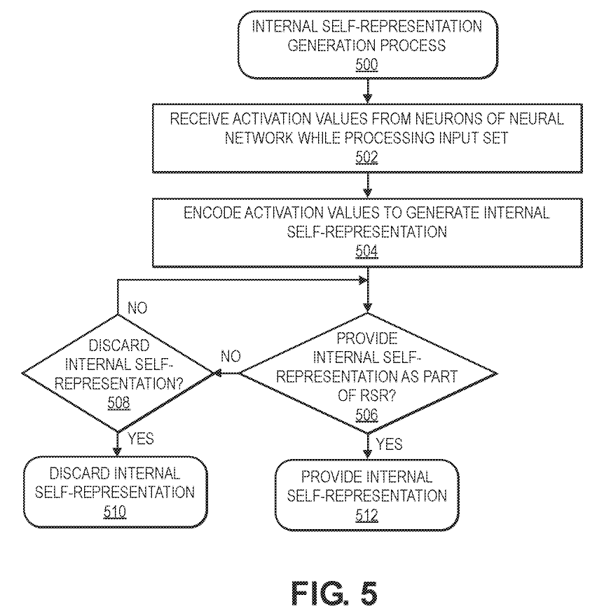

If the RSRS determines at decision block 410 to include the RSR in the input set with the received external input, if it is determined at decision block 404 that the RSR is to be used as the input set, or if it determined at decision block 408 that the RSR is to be included in the input set with a generated input, the RSRS determines whether to include an internal self-representation as part of the RSR, as in 412. As discussed herein, an internal self-representation is generated by the introspective system based on activation values generated by neurons of the neural network 111 as the neural network processed a prior input set. If the RSRS determines that the internal self-representation is to be included in the RSR, the RSRS obtains an internal self-representation generated by the introspective system 113 of the RSRS from a prior input set, as in 414. Generation of an internal self-representation from an input set is discussed further below with respect to FIG. 5.

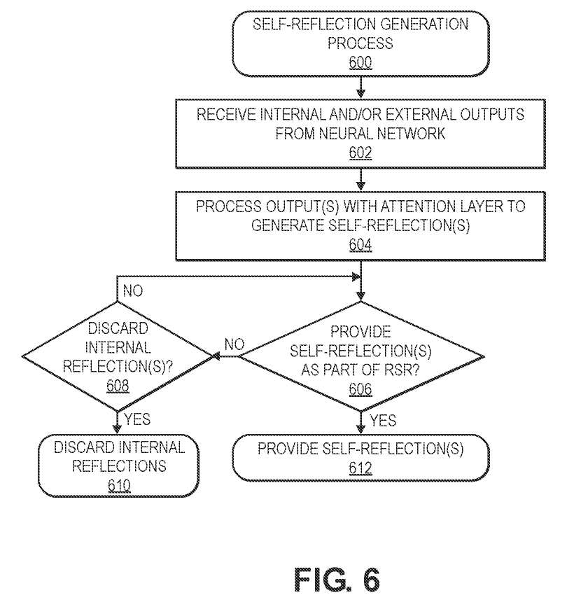

In addition to obtaining the internal self-representation for inclusion as part of the RSR, or if the RSRS determines at decision block 412 that the internal self-representation is not to be included in the RSR, the RSRS determines if a self-reflection is to be included as part of the RSR, as in 416. If the RSRS determines that the self-reflection is to be included in the RSR, the RSRS obtains a self-reflection generated by the introspective system 113 of the RSRS from a prior input set, as in 418. Generation of a self-reflection from an input set is discussed further below with respect to FIG. 6.

After generating the RSR to include in the internal self-representation (414) and/or the self-reflection (418), if the RSRS determines that the self-reflection is not to be included in the RSR (416), if the RSRS determines that the RSR is not to be included in the input set with the external input (410), or if the RSRS determines that the RSR is not to be included in the input set with the generated input (408), the RSRS 110, or the introspective system 113 of the RSRS, provides the input set to the neural network 111, as in 420.

The neural network 111, upon receipt of the input set, processes the input set to produce one or more outputs, as in 422. As discussed, as the input(s) of the input progresses through the layers of the neural network 111, activation values are generated by each of the neurons of the neural network. As illustrated in FIG. 4, as the neural network processes the input set to generate an output set, the internal self-representation process 500 (FIG. 5) and the self-reflection process 600 (FIG. 6) are performed to generate an internal self-representation and a self-reflection, respectively.

Finally, the RSRS completes by proving the external output of the output set from the RSRS as responsive to the external inputs of the input set, as in 426. External outputs may be any of the outputs discussed above with respect to FIG. 1, and/or other outputs.

FIG. 5 is an example internal self-representation generation process 500, in accordance with described implementations. The example process 500 is performed while a neural network is processing an input set to produce an output set based on the input set. In some implementations, the example process 500 is performed by the processing component 251 of the introspective system 113, discussed above with respect to FIG. 2. As discussed, in some implementations, the processing component 251 may be an autoencoder. In other implementations, the processing component may be an activation layer. In still other examples, the processing component may include one or more other or additional components that are configured to process activation values observed from neurons of the neural network 111 and produce an internal self-representation as disclosed herein.

The example process 500 begins with the processing component 251 receiving activation values observed from neurons of the neural network while the neural network is processing an input set, as in 502. For example, the activation values may be the activation values of each neuron of neural network after the neuron applies the activation function to the input data received by the neuron. In some implementations, the activation values are observed by the activation monitor 250 of the introspective system 113. In other implementations, the processing component 251 may observe or receive the activation values directly from the neural network 111 and/or the neurons of the neural network.

Upon receipt of the activation values from neurons of the neural network by the processing component, the processing component 251 encodes the activation values to generate an internal self-representation, as in 504. For example, if the processing component 251 is an autoencoder, the autoencoder may encode the activation values through a bottleneck to produce an internal self-representation embedding. If the processing component 251 is an attention layer, the attention layer may process the elements (activation values) with respect to other elements (activation values) and apply attention weights that emphasize one or more elements over other elements to produce the internal self-representation.

After the internal self-representation is generated, the RSRS determines if the internal self-representation is to be provided as part of the RSR, as in 506. As discussed above with respect to FIG. 4, the RSRS may decide whether a prior internal self-representation is to be included in an RSR. If the RSRS determines that the internal self-representation is to be included in the RSR, the RSR generated in accordance with the example process 500 is provided, as in 512. If the RSRS determines that the internal self-representation is not to be provided (e.g., there has not been another external input received), the RSRS determines if the internal self-representation is to be discarded, as in 508. For example, if a received input set corresponds to a different task that is irrelevant to the task performed by the neural network when the RSR was generated, the RSRS may determine that the internal self-representation is not relevant and is to be discarded. In comparison, the RSRS may determine that the internal self-representation is not to be discarded as it may be needed later, such as if an external input set and/or a generated input is subsequently received/generated.

If the RSRS determines that the internal self-representation is not to be discarded, the RSRS maintains the internal self-representation, such as in a memory or buffer, and the example process 500 returns to decision block 506, and continues. If it is determined that the internal self-representation is to be discarded, the RSRS discards the internal self-representation, as in 510.

FIG. 6 is an example self-reflection generation process 600, in accordance with described implementations. The example process 600 is performed while a neural network is processing an input set to produce an output set based on the input set. In some implementations, the example process 600 is performed by the output attention layer 254 of the introspective system 113, discussed above with respect to FIG. 2. In other implementations, the example process 600 may be performed by another component or components of the introspective system 113 that are configured to process outputs of the neural network 111 and produce one or more self-reflections 231, as disclosed herein.

The example process 600 begins with the output attention layer 254 receiving external outputs and/or internal outputs of an output set generated by the neural network 111, as in 602. As discussed above, in some implementations, the neural network 111 may be trained to generate internal outputs as part of a processing of an input set and those internal outputs may not be provided external of the RSRS 110. In such an implementation, those internal outputs function as the thoughts, experiences, etc., of the neural network from processing an input set. Alternatively, or in addition thereto, the external outputs, which are provided external of the RSRS as responsive to the input set, may also be provided to the output attention layer 254.

Upon receipt of the output(s) from the neural network, the output attention layer 254 processes the received outputs to produce one or more self-reflections, as in 604. For example, the output attention layer may process the outputs and/or elements of the outputs by applying attention weights that emphasize one or more outputs and/or elements of an output over other outputs or elements of the same or other outputs to produce the self-reflection of the neural network.

After the self-reflection is generated, the RSRS determines if the self-reflection is to be provided for inclusion in an RSR, as in 606. As discussed above with respect to FIG. 4, the RSRS may decide whether a prior self-reflection is to be included in an RSR. If the RSRS determines that the self-reflection is to be included in the RSR, the RSR generated in accordance with the example process 600 is provided, as in 612. If the RSRS determines that the self-reflection is not to be provided (e.g., there has not been another external input received), the RSRS determines if the self-reflection is to be discarded, as in 608. For example, if the received input corresponds to a different task that is irrelevant to the task performed by the neural network when the RSR was generated, the RSRS may determine that the self-reflection is not relevant and is to be discarded. In comparison, the RSRS may determine that the self-reflection is not to be discarded as it may be needed later, such as if an external input and/or a generated input is subsequently received/generated.

If the RSRS determines that the self-reflection is not to be discarded, the RSRS maintains the self-reflection, such as in a memory or buffer, and the example process 600 returns to decision block 606, and continues. If it is determined that the self-reflection is to be discarded, the RSRS discards the internal self-representation, as in 610.

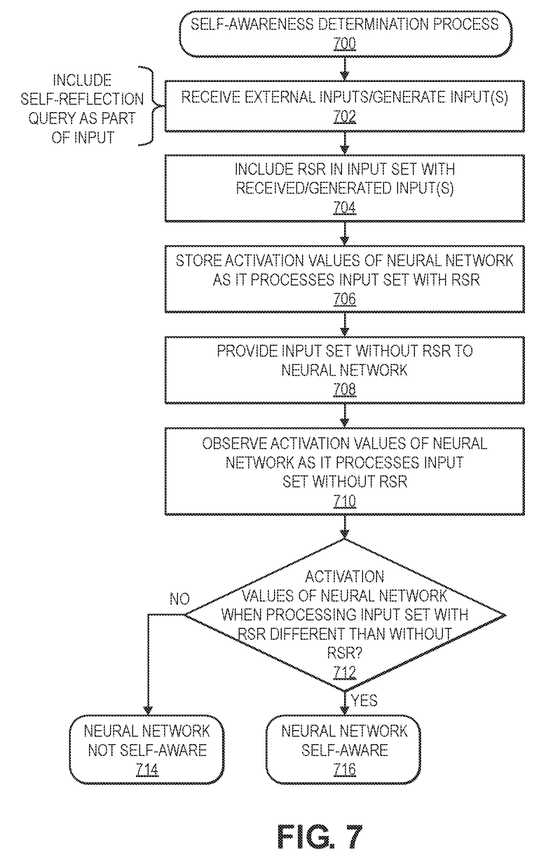

FIG. 7 is an example self-awareness determination process 700, in accordance with described implementations. The example process 700 may be performed by the self-awareness component 252 of the introspective system 113. In some implementations, the example process 700 may be periodically performed (e.g., hourly, daily, weekly, etc.) to determine if the neural network is self-aware.

The example process 700 begins with the RSRS receiving an external input or generating an input that is to be included in an input set provided to the neural network 111, as in 702. In some examples, the self-awareness component may cause the input generator 256 to generate a self-reflection query (e.g., How are you feeling?) that is to be included as the input of the input set sent to the neural network 111 as part of the example process 700 and a determination as to whether the neural network is self-aware. In other implementations, any input, such as an external input may be utilized with the example process 700.

With an input included in the input set, whether external or generated, the self-awareness component 252 includes into the input set, an RSR generated from a prior processing by the neural network of a prior input, as in 704. The self-awareness component then provides the input set, with the RSR, to the neural network. As the neural network processes the input set, the activation monitor 250 of the introspective system 113 observes the activation values of the neurons generated as the neural network 111 processes the input set and the self-awareness component 252 receives and stores those observed activation values, as in 706. After the activation values are observed and stored, and the neural network has processed the input set with the included RSR, the self-awareness component 252 causes a second input set that is devoid of the RSR to be provided to the neural network for processing, as in 708. In some implementations, the second input set that is devoid of the RSR may include the same input included in the first input set that was processed by the neural network and used by the example process 700 to record the first activation values. In other implementations, the second input set may include a different input, but again the second input is devoid of the RSR.

The neural network 111 then processes the second input set that is devoid of the RSR and the activation monitor and/or self-awareness component again observes and records the activation values generated by neurons of the neural network as the neural network processes the second input set that is devoid of the RSR, as in 710.

The self-awareness component may then determine if the activation values of the neural network when processing the first inputs set with the RSR are substantially different than the activation values of the neural network when processing the second input set that is devoid of the RSR, as in 712. If the self-awareness component 252 determines that the first activation values observed when the neural network processed the first input set that includes the RSR are substantially different than the second activation values observed when the neural network processed the second input set that is devoid of the RSR, the self-awareness component 252 quantifiably determines that the neural network is self-aware, as in 716. In some implementations, it may be determined that the activation values are substantially different when the difference exceeds a defined difference threshold.

The difference in activation values quantifiably illustrates that the neural network is utilizing its own RSR to influence the processing and ultimate output from the neural network because the different activation values illustrate that the neural network is paying attention to the RSR as part of the input set. In comparison, if the self-awareness component determines that the first activation values are not substantially different (e.g., does not exceed the difference threshold) than or the same as the second activation values, it is quantifiably determined that the neural network is not self-aware, as in 714, because the neural network is not paying attention to the RSR input of the first input set.

While the example process 700 describes recording and comparing first activation values generated when the neural network processes a first input set that includes an RSR with second activation values generated when the neural network processes a second input set that is devoid of the RSR to determine if the neural network is self-aware, the order is not important. In other implementations, the self-awareness component may send to the neural network a first input set that is devoid of the RSR, record first activation values from a processing of the first input set, then send a second input set that includes the RSR for processing with the neural network and record activation values from a processing of the second input set. In either example, the difference between the activation values may be determined and utilized to quantifiably assess whether or not the neural network is self-aware.

In still other examples and again regardless of the order of processing of the input sets (with or without the RSR), the self-awareness component 252, rather than comparing activation values observed from the neural network may instead (or additionally) determine a difference between a first internal self-representation generated by the processing component in response to the first activation values with a second internal self-representation generated by the processing component in response to the second activation values. For example, if the first internal self-representation and the second internal self-representation are generated by an autoencoder and are embeddings, a distance between the two embeddings in the vector space may be determined. If the distance exceeds a defined threshold, the self-awareness component determines that the neural network is self-aware because it is paying attention to its own RSR. If the distance does not exceed the defined threshold, the self-awareness component determines that the RSR is not self-aware.

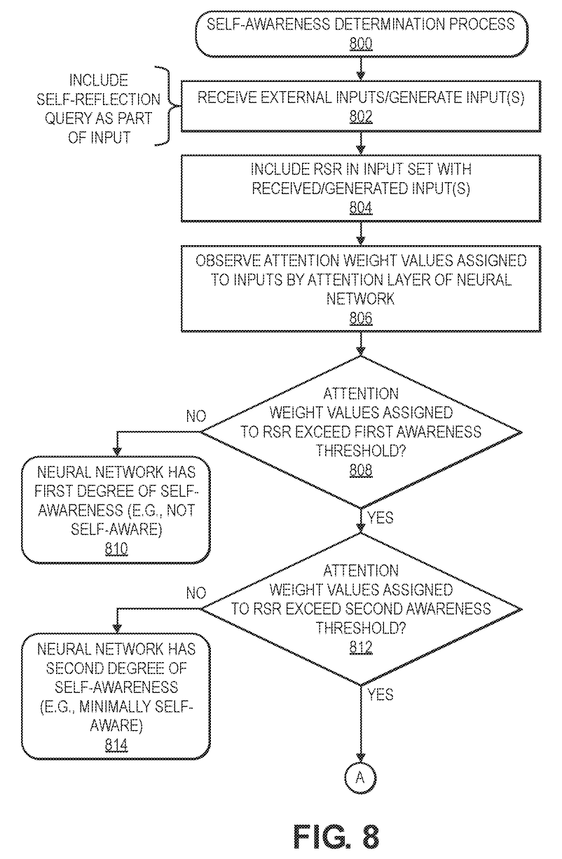

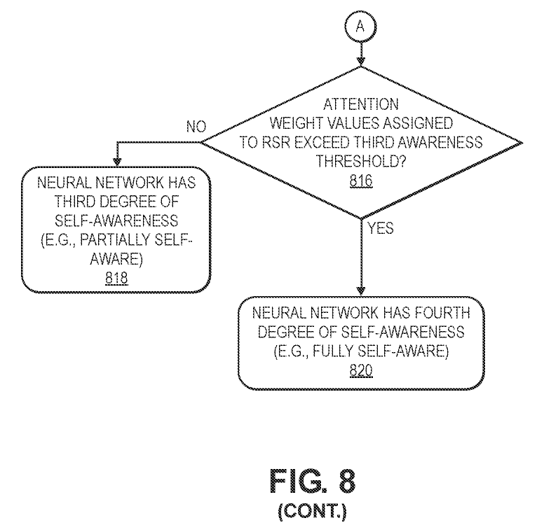

FIG. 8 is another example self-awareness determination process 800, in accordance with described implementations. The example process 800 may be performed by the self-awareness component 252 of the introspective system 113. In some implementations, the example process 800 may be periodically performed (e.g., hourly, daily, weekly, etc.) to determine if the neural network is self-aware and/or to determine a degree of self-awareness of the neural network.

The example process 800 begins with the RSRS receiving an external input or generating an input that is to be included in an input set provided to the neural network 111, as in 802. In some examples, the self-awareness component 252 may cause the input generator to generate a self-reflection query (e.g., How are you feeling?) that is to be included as the input of the input set sent to the neural network 111 as part of the example process 800 and determination as to whether the neural network is self-aware and/or a degree of self-awareness. In other implementations, any input, such as an external input may be utilized with the example process 800. In addition to including an external or generated input to the input set, the RSR is included in the input set, as in 804.

With an input included in the input set, whether external or generated, and provided to the neural network, the attention monitor 253 of the introspective system 113 monitors the input attention layer to observe attention weight values applied by the input attention layer 203 to the different inputs of the input set and/or different elements of inputs of the input set, as in 806. The observed attention weight values may then be provided to the self-awareness component. In other implementations, the self-awareness component 252 may directly observe and record the attention weight values.

The self-awareness component then determines if the attention weight values assigned to the RSR of the input set exceed a first awareness threshold, as in 808. While the examples discussed herein describe the attention weight values exceeding a threshold, in some implementations, some or all of the attention weight values assigned to the RSR of the input set may be aggregated (e.g., mean, median, standard deviation, summed), a Gaussian distribution, or other representations, etc. In each such example, the representation of the attention weight values may be compared to a corresponding threshold or range to determine if the neural network is self-aware and/or to determine a degree of self-awareness of the neural network.

For example, the first awareness threshold may be any value or other indicator that may be used as a comparison with the observed attention weight values. In some implementations, the first awareness threshold may be zero such that if there is any attention weight value above zero, it is determined that the observed attention weight values exceed the first awareness threshold. In other implementations, the first awareness threshold may have a different value. If it is determined that the attention weight values assigned to the RSR input and/or RSR input elements do not exceed the first awareness threshold, the self-awareness component determines that the neural network has a first degree of self-awareness (e.g., not self-aware), as in 810.

If the self-awareness component determines that the attention weight values exceed the first awareness threshold, the self-awareness component determines if the attention weight values exceed a second awareness threshold that is higher than the first awareness threshold, as in 812. Like the first awareness threshold, the second awareness threshold may be any defined value, indicator, distribution, etc., that may be used as a comparison with the observed attention weight values. If the self-awareness component determines that the attention weight values do not exceed the second awareness threshold, the self-awareness component determines that the neural network has a second degree of self-awareness (e.g., minimally self-aware), as in 814.

If the self-awareness component determines that the attention weight values exceed the second awareness threshold, the self-awareness component determines if the attention weight values exceed a third awareness threshold that is higher than the second awareness threshold, as in 816. Like the second awareness threshold, the third awareness threshold may be any defined value, indicator, distribution, etc., that may be used as a comparison with the observed attention weight values. If the self-awareness component determines that the attention weight values do not exceed the third awareness threshold, the self-awareness component determines that the neural network has a third degree of self-awareness (e.g., partially self-aware), as in 818.

If the self-awareness component determines that the observed attention weight values exceed the third awareness threshold, the self-awareness component determines that the neural network has a fourth degree of self-awareness (e.g., fully self-aware), as in 820.

While the example process 800 discusses three awareness thresholds and determining four different degrees of self-awareness of a neural network 111, in other implementations, there may be fewer or additional thresholds and/or degrees of self-awareness. For example, the example process 800 may only utilize a single threshold. In such an example, if the observed attention weight values applied to the RSR input or elements of the RSR input exceed the threshold, it is determined that the neural network is self-aware. If the observed attention weight values do not exceed the threshold, the neural network is determined to be not self-aware. In still other examples, there may be additional levels of awareness thresholds and corresponding levels of self-awareness.

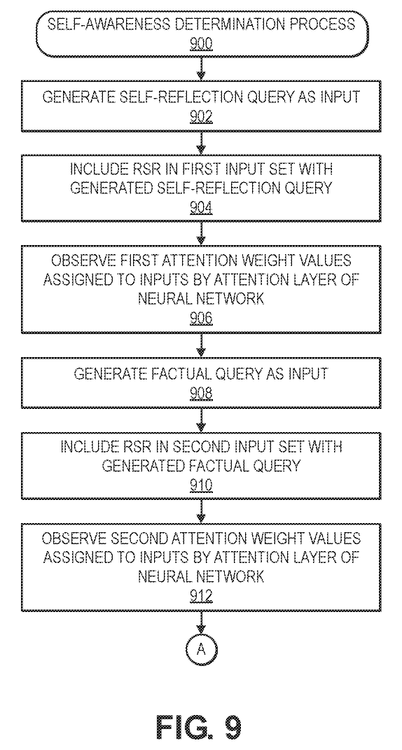

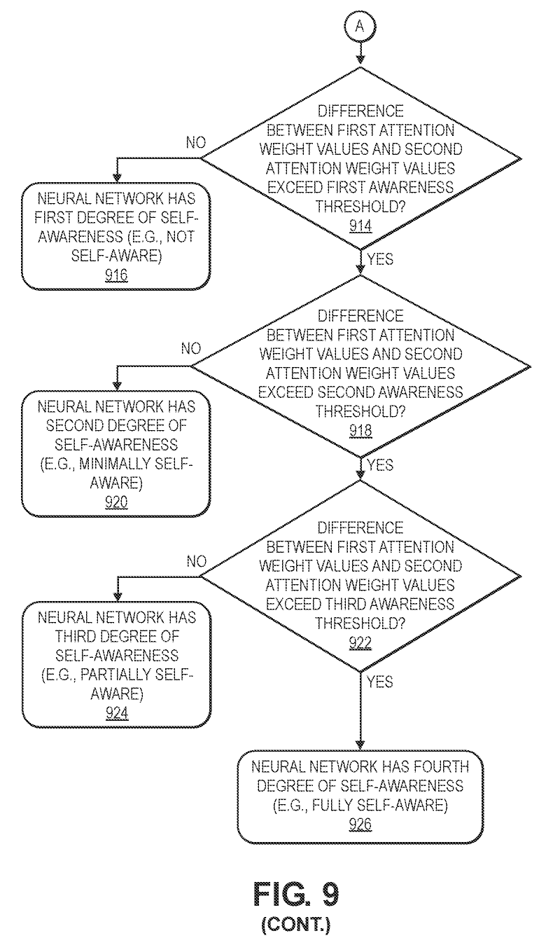

FIG. 9 is another example self-awareness determination process, in accordance with described implementations. The example process 900 may be performed by the self-awareness component 252 of the introspective system 113. In some implementations, the example process 900 may be periodically performed (e.g., hourly, daily, weekly, etc.) to determine if the neural network is self-aware and/or to determine a degree of self-awareness of the neural network.

The example process 900 begins with the RSRS generating a self-reflection query as an input that is to be included in a first input set provided to the neural network 111, as in 902. The self-reflection query may be any form of self-reflection, such as, “How are you feeling?”, “How is your day going?”, “Are you happy?”, etc. The generated self-reflection query is then included in a first input set with the RSR, as in 904.

With the generated self-reflection query included in the first input set with the RSR, the attention monitor 253 of the introspective system 113 monitors the input attention layer to observe first attention weight values applied by the input attention layer 203 to the different inputs of the first input set and/or different elements of inputs of the first input set, as in 906. In some implementations, only the attention weight values assigned to the RSR aspects of the input may be observed. In other examples, all attention weight values may be observed. The observed first attention weight values may then be provided to the self-awareness component. In other implementations, the self-awareness component 252 may directly observe and record the first attention weight values.

The RSRS then generates a factual query (or other non-self-reflection query) as an input that is to be included in a second input set provided to the neural network 111, as in 908. The factual query may be any form of query that is not a self-reflection query, such as, “What time is it?”, “What is the date?”, “How many continents are there?”, etc. The generated factual query is then included in a second input set with the RSR, as in 910.

With a generated factual query included in the second input set with the RSR, the attention monitor 253 of the introspective system 113 monitors the input attention layer to observe second attention weight values applied by the input attention layer 203 to the different inputs of the second input set and/or different elements of inputs of the second input set, as in 912. In some implementations, only the attention weight values assigned to the RSR aspects of the input may be observed. In other examples, all attention weight values may be observed. The observed second attention weight values may then be provided to the self-awareness component. In other implementations, the self-awareness component 252 may directly observe and record the second attention weight values.

The self-awareness component then determines if a difference between the first attention weight values and the second attention weight values exceed a first awareness threshold, as in 914. While the examples discussed herein describe the difference between the first attention weight values and the second attention weight values exceeding a threshold, in some implementations, some or all of the first attention weight values and the second attention weight values may be separately aggregated (e.g., mean, median, standard deviation, summed), a Gaussian distribution, or other representations, etc., and those aggregations compared to determine the difference. In each such example, the difference between the first attention weight values and the second attention weight values may be compared to a corresponding threshold or range to determine if the neural network is self-aware and/or to determine a degree of self-awareness of the neural network.

For example, the first awareness threshold may be any value or other indicator that may be used as a comparison with the difference between the observed first attention weight values and the observed second attention weight values. In some implementations, the first awareness threshold may be zero such that if there is any difference between the first attention weight values and the second attention weight values, it is determined that the difference exceeds the first awareness threshold. In other implementations, the first awareness threshold may have a different value. If it is determined that the difference between the first attention weight values assigned to the first RSR input and/or first RSR input elements and the second attention weight values assigned to the second RSR input and/ or the second RSR input elements do not exceed the first awareness threshold, the self-awareness component determines that the neural network has a first degree of self-awareness (e.g., not self-aware), as in 916.

If the self-awareness component determines that the difference between the first attention weight values and the second attention weight values exceeds the first awareness threshold, the self-awareness component determines if the difference between the first attention weight values and the second attention weight values exceeds a second awareness threshold that is higher than the first awareness threshold, as in 918. Like the first awareness threshold, the second awareness threshold may be any defined value, indicator, distribution, etc., that may be used as a comparison with the difference between the first attention weight values and the second attention weight values. If the self-awareness component determines that the difference between the first attention weight values and the second attention weight values does not exceed the second awareness threshold, the self-awareness component determines that the neural network has a second degree of self-awareness (e.g., minimally self-aware), as in 920.

If the self-awareness component determines that the difference between the first attention weight values and the second attention weight values exceeds the second awareness threshold, the self-awareness component determines if the difference between the first attention weight values and the second attention weight values exceeds a third awareness threshold that is higher than the second awareness threshold, as in 922. Like the second awareness threshold, the third awareness threshold may be any defined value, indicator, distribution, etc., that may be used as a comparison with the difference between the first attention weight values and the second attention weight values. If the self-awareness component determines that the difference between the first attention weight values and the second attention weight values do not exceed the third awareness threshold, the self-awareness component determines that the neural network has a third degree of self-awareness (e.g., partially self-aware), as in 924.

If the self-awareness component determines that the difference between the first attention weight values and the second attention weight values exceeds the third awareness threshold, the self-awareness component determines that the neural network has a fourth degree of self-awareness (e.g., fully self-aware), as in 926.

While the example process 900 discusses three awareness thresholds and determining four different degrees of self-awareness of a neural network 111, in other implementations, there may be fewer or additional thresholds and/or degrees of self-awareness. For example, the example process 900 may only utilize a single threshold. In such an example, if the difference between the first attention weight values and the second attention weight values exceeds the threshold, it is determined that the neural network is self-aware. If the difference between the first attention weight values and the second attention weight values does not exceed the threshold, the neural network is determined to be not self-aware. In still other examples, there may be additional levels of awareness thresholds and corresponding levels of self-awareness.

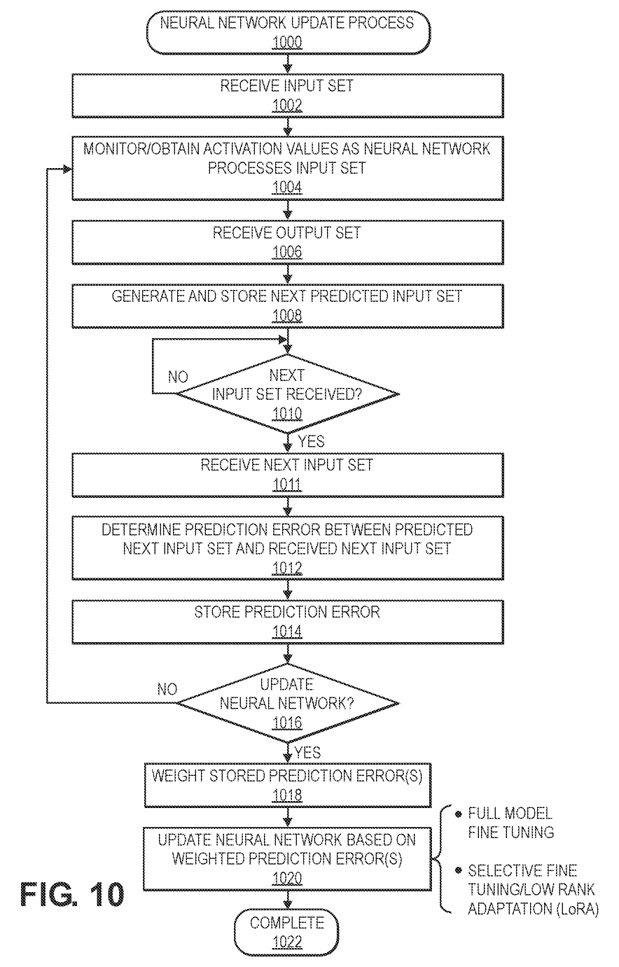

FIG. 10 is an example neural network update process 1000, in accordance with described implementations. The example neural network update process 1000 may be performed by the neural network update component 255 of the introspective system 113.

The example process 1000 begins when the neural network receives an input set, as in 1002. As discussed above, the input set may include one or more external inputs, one or more generated inputs, and/or an RSR generated by the introspective system 113 from a processing by the neural network 111 of a prior input set.

The neural network update component 255 may then observe or obtain the activation values of the neurons of the neural network 111 as the neural network 111 processes the inputs set, as in 1004. In some implementations, the activation monitor may observe the activation values and provide those values to the neural network update component 255. In other examples, the neural network update component 255 may directly observe or obtain the activation values. In some implementations, the network update component may also observe or obtain the attention weight values applied to the inputs/input elements by the input attention layer of the neural network as part of the example process 1000.

The neural network update component 255 may also obtain or receive the outputs, whether external outputs and/or internal outputs, generated by the neural network in response to processing the input set, as in 1006.

Based at least in part on the input set, the observed activation values (and optionally the observed attention weight values) generated during processing of the neural network, and the output set generated by the neural network 111 when processing the input set, the neural network update component generates and stores a next predicted input set, as in 1008. For example, the neural network update component 255 may include a second neural network that is trained to receive one or more input sets provided to the neural network 111 and the corresponding one or more outputs produced by the neural network 111, and predict a next predicted input set that will be received by the neural network 111.

After generating a predicted next input set, the neural network update component determines if the actual next input set has been received at the neural network, as in 1010. If the actual next input set has not been received, the example process 1000 remains at decision block 1010 until the actual next input set is received. When the neural network update component determines that the actual next input is received, the neural network update component receives the next input set, as in 1011, and determines a prediction error between the predicated next input set and the received actual next input set, as in 1012. The determined prediction error is then stored, as in 1014. Each prediction error represents a difference between a predicted input set generated by a neural network update component and the actual input set subsequently received by the neural network.

Upon determination and storage of the prediction error, the neural network update component determines whether to update the neural network, as in 1016. It may be determined to update the neural network if, for example, the prediction error exceeds an error threshold. As another example, it may be determined that the neural network is to be updated after a defined period of time (e.g., weekly, monthly) has elapsed since a last update of the neural network. In still other examples, the neural network may be updated each time a prediction error is determined.

If the neural network determines that the neural network is not to be updated, the example process 1000 returns to block 1004 and continues. If the neural network update component determines that the neural network is to be updated, the stored prediction errors may be weighted, as in 1018. Weighting may be applied to account for temporal differences between stored prediction errors, with more recent prediction errors given higher weights than older prediction errors. In other examples, weighting may be applied to assign higher weights to larger prediction errors. The higher/larger the weight, the more importance the prediction error is compared to other prediction errors.

Utilizing the weighted prediction errors, the neural network update component 255 may cause the neural network 111 to transition from an inference state to a training state and cause an update of the neural network 111 based on the weighted prediction errors, as in 1020. For example, the neural network update component may perform full model fine tuning based on the recorded prediction errors to update parameters of the neurons of the neural network 111. In other implementations, the neural network update component may perform selective fine-tuning, such as Low-Rank Adaptation (“LoRA”) to freeze some weights of the neural network and update other weights of the neural network.

After the neural network is updated/tuned, the neural network update component may transition the neural network back to inference mode and the example process 1000 completes, as in 1022.

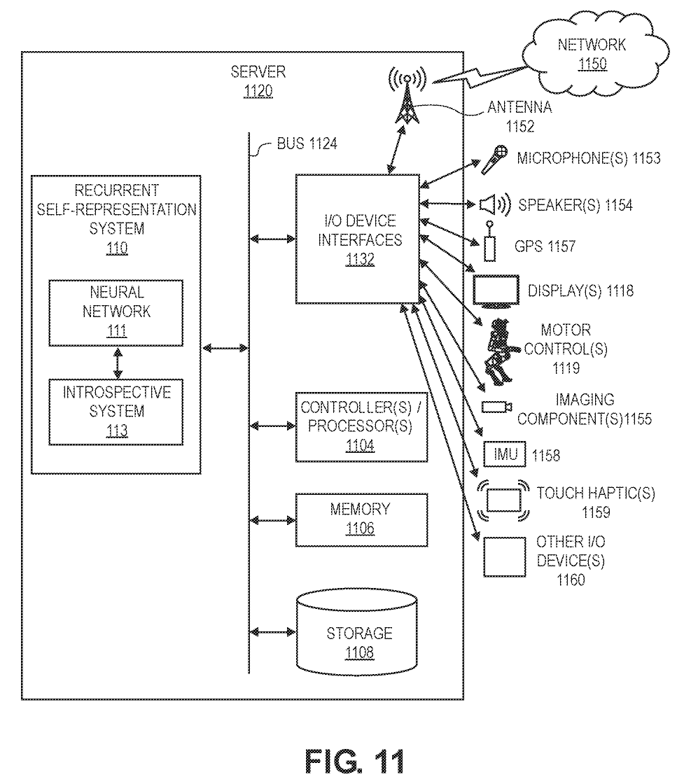

FIG. 11 is a block diagram illustrating an exemplary computing resource, such as a server 1120, upon which the recurrent self-representation system 110 may operate, in accordance with described implementations. Multiple such servers 1120 may be included in the system or environment to enable operation of the RSRS 110 and/or other components/systems utilizing the RSRS 110.

The server 1120 may include one or more controllers/processors 1104, that may each include one or more central processing units (“CPUs”) for processing data and computer-readable instructions, and a memory 1106 for storing data and instructions of the respective device. The memories 1106 may individually include volatile random access memory (“RAM”), non-volatile read only memory (“ROM”), non-volatile magnetoresistive (“MRAM”) and/or other types of memory. Each server may also include a data storage component 1108, for storing data, controller/processor-executable instructions, training data, attention weight values, activation values, prediction errors, etc. Each data storage component may individually include one or more non-volatile storage types such as magnetic storage, optical storage, solid-state storage, etc. Each server may also be connected to removable or external non-volatile memory and/or storage (such as a removable memory card, memory key drive, networked storage, etc.), internal, and/or external networks 1150 (e.g., the Internet) through respective input/output device interfaces 1132.

Computer instructions for operating the server 1120 and its various components may be executed by the respective server’s controller(s)/processor(s) 1104, using the memory 1106 as temporary “working” storage at runtime. A server’s computer instructions may be stored in a non-transitory manner in non-volatile memory 1106, storage 1108, or an external device(s). Alternatively, some or all of the executable instructions may be embedded in hardware or firmware on the respective device in addition to or instead of software. The server 1120 may also include the RSRS 110, which includes the neural network 111 and communicatively coupled introspective system 113 that operate as discussed herein.

A variety of components may be connected through the input/output device interfaces 1132. For example, if the RSRS is utilized by an autonomous system, the input/output device interfaces 1132 may interface with any of a variety of input/output devices. Example input/output devices that may interface with the server include, but are not limited to an antenna 1152 that may provide wireless communication with the network 1150, microphone(s) 1153, speaker(s) 1154, global positioning systems (“GPS”) 1157, display(s) 1118, motor controls 1119, imaging component(s) 1155, inertial measurement units (“IMU”) 1158, touch/haptic devices 1159, and/or other input/output devices 1160.

Additionally, the server 1120 may include an address/data bus 1124 for conveying data among components of the server. Each component within a server 1120 may also be directly connected to other components in addition to (or instead of) being connected to other components across the bus 1124.

The components of the server(s) 1120, as illustrated in FIG. 11, are exemplary, and may be located as a stand-alone device or may be included, in whole or in part, as a component of a larger device or system.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Persons having ordinary skill in the field of computers, communications, artificial intelligence, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein and/or that some steps or components discussed herein may be performed serially or in parallel. With respect to the one or more methods or processes of the present disclosure described herein, including but not limited to the flow chart shown in FIGS. 3 through 10, orders in which such methods or processes are presented are not intended to be construed as any limitation on the claimed inventions, and any number of the method or process steps or boxes described herein can be combined in any order and/or in parallel to implement the methods or processes described herein. Additionally, it should be appreciated that the detailed description is set forth with reference to the accompanying drawings, which are not drawn to scale.

Aspects of the disclosed systems may be implemented as a computer method or as an article of manufacture such as a memory device or non-transitory computer-readable storage medium. The computer-readable storage medium may be readable by a computer and may comprise instructions for causing a computer or other device to perform processes described in the present disclosure. The computer-readable storage media may be implemented by a volatile computer memory, non-volatile computer memory, hard drive, solid-state memory, flash drive, removable disk, virtual drive, and/or other media.

The data and/or computer-executable instructions, programs, firmware, software and the like (also referred to herein as “computer-executable” components) described herein may be stored on a computer-readable medium that is within or accessible by computers or computer components, or to any other computers or control systems, and having sequences of instructions which, when executed by one or more processors (e.g., CPU, GPU), cause the one or more processors to perform all or a portion of the functions, services, systems, and/or methods described herein. Such computer-executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, virtual drives, remote drives, or other types of media/machine-readable medium that may be suitable for storing electronic instructions. Further, implementations may also be provided as a computer-executable program product that includes a transitory machine-readable signal (in compressed or uncompressed form).

Most examples use at least one network that would be familiar to those skilled in the art for supporting communications using any of a variety of widely available protocols, such as Transmission Control Protocol / Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

References to “one example,” “an example,” “one implementation,” “an implementation,” etc., indicate that the example or implementation described may include a particular feature, structure, or characteristic, but every example or implementation may not necessarily include the particular feature, structure, or characteristic. Moreover, such phrases are not necessarily referring to the same example or implementation. Further, when a particular feature, structure, or characteristic is described in connection with an example or implementation, it is submitted that it is within the knowledge of one skilled in the art to affect such feature, structure, or characteristic in connection with other examples or implementations whether or not explicitly described.

Moreover, in the various examples and implementations described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example or implementations requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A system, comprising:
a neural network including a plurality of layers, each layer including a plurality of neurons;
an introspective system coupled with the neural network, the introspective system including, at least:
an activation monitor configured to at least record first activation values of each of the plurality of neurons of each of the plurality of layers of the neural network as the neural network processes a first input set received by the neural network at a first time to produce a first output set; and
an autoencoder configured to at least:
receive the first activation values from the activation monitor;
encode at least some of the first activation values into a first internal self-representation embedding of the neural network; and
provide the first internal self-representation embedding as at least a portion of a second input set to the neural network at a second time that is subsequent to the first time; and
the neural network configured to, at least:
receive the second input set; and
process the second input set to produce a second output set responsive to the second input set that is based at least in part on the first internal self-representation embedding such that the second output set is influenced by the first internal self-representation embedding of the neural network.

2. The system of claim 1, the introspective system, further comprising:
an attention layer, configured to at least:
receive an output embedding of the first output set;
produce a self-reflection embedding by performing a self-attention weighting within the output embedding that includes assigning a first weight to a first element of the output embedding to emphasize an importance of that first element of the output embedding with respect to a second element of the output embedding; and
provide the self-reflection embedding as at least a portion of the second input set to the neural network.

3. The system of claim 1, the introspective system, further comprising:
an attention layer configured to at least:
receive a first output embedding and a second output embedding of the first output set;
produce a first self-reflection embedding and a second self-reflection embedding by performing a cross-attention weighting between the first output embedding and the second output embedding that includes assigning a first weight to the first output embedding to emphasize an importance of that first output embedding with respect to the second output embedding; and
provide the first self-reflection embedding and the second self-reflection embedding as at least a portion of the second input set to the neural network.

4. The system of claim 1, the introspective system, further comprising:
a self-awareness component, configured to at least:
receive, from the activation monitor, second activation values of each of the plurality of neurons of each of the plurality of layers of the neural network as the neural network processes the second input set received by the neural network at the second time to produce the second output set,
wherein the second input set includes the first internal self-representation and a query;
cause a third input set to be provided to the neural network at a third time,
wherein the third input set is devoid of the first internal self-representation and includes the query;
receive, from the activation monitor, third activation values of each of the plurality of neurons of each of the plurality of layers of the neural network as the neural network processes the third input set received by the neural network at the third time to produce a third output set; and
determine, based at least in part on a difference between the second activation values and the third activation values, that the neural network is self-aware.

5. The system of claim 1, the introspective system, further comprising:
a self-awareness component, configured to at least:
receive, from an attention monitor, an attention weight value assigned by an attention layer of the neural network to the first internal self-representation embedding included in the second input set; and
determine, based at least in part on the attention weight value, that the neural network is at least one of self-aware, minimally self-aware, partially self-aware, or fully self-aware.

6. A method, comprising:
receiving, at an introspective system, a plurality of activation values produced by a plurality of neurons of a neural network as the neural network processes a first input set to produce a first output set;
processing, with the introspective system, at least some of the plurality of activation values to produce a first internal self-representation of the neural network; and
processing, with the neural network, a second input set that includes at least the first internal self-representation to produce a second output set that is based at least in part on the first internal self-representation, such that the second output set is influenced by the first internal self-representation of the neural network.

7. The method of claim 6, further comprising:
processing, with an attention layer of the introspective system, at least a portion of the second output set to produce a self-reflection of the neural network by applying attention weight values to at least a first element of the at least a portion of the second output set to emphasize the first element with respect to at least a second element of the at least a portion of the second output set; and
including the self-reflection in the second input set that is processed by the neural network to produce the second output set, such that the second output set is influenced by the first internal self-representation of the neural network and the self-reflection of the neural network.

8. The method of claim 7, wherein:
the second output set includes an internal output generated by the neural network in response to the second input set that is not provided externally in response to the second input set; and
the internal output is at least one of a text output, a visual output, a motor control, a spatial output, an emotional output, or an audio output.

9. The method of claim 7, wherein:
the second output set includes an external output generated by the neural network in response to the second input set that is provided externally in response to the second input set; and
the external output is at least one of a text output, a visual output, an audible output, or a motor control output.

10. The method of claim 6, further comprising:
receiving, at a self-awareness component of the introspective system, a second plurality of activation values produced by the plurality of neurons of the neural network as the neural network processes the second input set to produce the second output set, wherein the second input set includes the first internal self-representation;
processing, with the neural network, a third input set that is devoid of the first internal self-representation to produce a third output set;
receiving, at the self-awareness component, a third plurality of activation values produced by the plurality of neurons of the neural network as the neural network processes the third input set; and
determine, with the self-awareness component and based at least in part on a difference between the second plurality of activation values and the third plurality of activation values, that the neural network is self-aware.

11. The method of claim 6, further comprising:
receiving, at a self-awareness component of the introspective system, an attention weight value assigned by an input attention layer of the neural network to the first internal self-representation embedding included in the second input set; and
determining, with the self-awareness component and based at least in part on the attention weight value, a degree of self-awareness of the neural network.

12. The method of claim 6, wherein:
receiving, at the introspective system, the plurality of activation values, further includes:
receiving, with an autoencoder of the introspective system, the plurality of activation values produced by the plurality of neurons of the neural network as the neural network processes the first input set to produce the first output set; and
processing, with the introspective system, the at least some of the plurality of activation values, further includes:
processing, with the autoencoder, the at least some of the plurality of activation values to produce the first internal self-representation of the neural network.

13. The method of claim 6, wherein:
receiving, at the introspective system, the plurality of activation values, further includes:
receiving, with an attention layer of the introspective system, the plurality of activation values produced by the plurality of neurons of the neural network as the neural network processes the first input set to produce the first output set; and
processing, with the introspective system, the at least some of the plurality of activation values, further includes:
processing, with the attention layer, the at least some of the plurality of activation values to assign attention weight values to at least some of the activation values to produce the first internal self-representation of the neural network.

14. The method of claim 6, further comprising:
generating a predicted next input set that includes one or more inputs predicted to be received by the neural network;
receiving, at the neural network, a third input set;
determining, based at least in part on the predicted next input set and the third input set, a prediction error; and
updating, based at least in part on the prediction error, the neural network.

15. The method of claim 14, wherein updating, further includes:
storing the prediction error with a plurality of prediction errors determined for the neural network; and
updating, based at least in part on the plurality of prediction errors, including the prediction error, the neural network.

16. An introspective system, comprising:
a processing component, configured to at least:
receive a first plurality of activation values produced by a plurality of neurons of a neural network as the neural network processes a first input set to produce a first output set;
process the first plurality of activation values to produce a first internal self-representation of the neural network;
receive a second plurality of activation values produced by the plurality of neurons of the neural network as the neural network processes a second input set to produce a second output set, wherein the second input set includes the first internal self-representation of the neural network; and
process the second plurality of activation values to produce a second internal self-representation of the neural network; and
a self-awareness component, configured to at least:
receive attention weight values assigned to the first internal self-representation by an attention layer of the neural network as the neural network processes the second input set to produce the second output set; and
determine, based at least in part on the attention weight values, a degree to which the neural network is self-aware.

17. The introspective system of claim 16, wherein:
the first input set includes a self-reflective query;
the second input set includes a factual query; and
the self-awareness component is further configured to at least:
receive second attention weight values assigned to the second internal self-representation by the attention layer of the neural network as the neural network processes the first input set to produce the first output set; and
determine the degree to which the neural network is self-aware based at least in part on a difference between the attention weight values and the second attention weight values.

18. The introspective system of claim 16, further comprising:
an input generator configured to at least generate an input that is included in the second input set with the first internal self-representation.

19. The introspective system of claim 18, wherein the input is at least one of:
a self-reflection query for the neural network;
a first input generated based at least in part on the first internal self-representation; or
a second input generated based at least in part on at least a portion of the first output set.

20. The introspective system of claim 16, further comprising:
a second attention layer, configured to at least:
receive at least a portion of the first output set produced by the neural network; and
produce a self-reflection of the neural network by assigning at least one attention weight value to at least one element of the at least a portion of the first output set to emphasize an importance of the at least one element with respect to another element of the at least a portion of the first output set; and
include the self-reflection in the second input set provided to the neural network.
